(19) United States
(12) Patent Application Publication
(10) Pub. No.: US 2007/0036134 A1
(43) Pub. Date: Feb. 15, 2007

(54) Portable internet phone

(76) Inventors: Ing-Kai Huang, Hsinchu City (TW); Douglas Wang, Hsinchu City (TW)

Correspondence Address: HDSL, 4331 STEVENS BATTLE LANE, FAIRFAX, VA, 22033, US

(21) Appl. No.: 11/187,898

(22) Filed: Jul. 25, 2005

(51) Int. Cl. H04L 12/66

(52) U.S. Cl. 370/352

(57) ABSTRACT

A portable Internet phone uses a portable memory media with storage function and connected to a computer system. The portable memory media is linked to a network server through the computer system and network communication software stored in the portable memory media is performed to display a dialing number keypad (or address book) for peer-to-peer Internet phone dialing and answering. The portable memory media uses one of a wireless audio receiver/transmitter unit and an audio receiver/transmitter unit for peer-to-peer voice conversation to overcome the limitation of requiring the network communication software to be built-in the computer system.

### BACKGROUND OF THE INVENTION

1. Field of the Invention

The present invention relates to a portable Internet phone, more particularly to a portable Internet phone being able to link to a network server through a computer system to overcome the limitation of requiring the network communication software to be built-in the computer system.

2. Description of Prior Art

Network telecommunication technologies such as peer-to-peer voice transmission technologies (including peer-call or SIP phone) and Instant Messenger (IM) technologies (MSN MASSAGE, YAHOO MASSAGE, SKYPE and YAHOO BB) rely on Internet for duplex voice packet transmission. Therefore, user only needs to pay the fee of broadband connection or dial-up connection for network telecommunication service, even though the phone call is made to remote or foreign party.

The above-mentioned network telecommunication service, including peer-to-peer voice transmission technologies and instant messenger technologies, needs to install application software to a user computer and the user need to register his (her) own user account. Afterward, the user can dial a number or input an account of a called party and then uses the microphone and earphone of the computer for conversation once the connection is established. However, the above-mentioned network telecommunication service can only be performed by computer installed with peer-to-peer voice transmission and instant messenger software. The user cannot use peer-to-peer voice transmission and instant messenger service by computer without installing any one of licensed peer-to-peer voice transmission and instant messenger software. It is inconvenient for user traveling to other place and not bringing own computer.

### SUMMARY OF THE INVENTION

The present invention is intended to provide a portable Internet phone being able to link to a network server through a computer system to overcome the limitation of requiring the network communication software to be built-in the computer system, wherein the portable Internet phone can establish peer-to-peer voice conversation with a remote IP phone anywhere through a computer with network accessing ability.

Accordingly, the present invention provides a portable Internet phone using a portable memory media with storage function and connected to a computer system. The portable memory media is linked to a network server through the computer system and network communication software stored in the portable memory media is performed to display a dialing number keypad (or address book) for peer-to-peer Internet phone dialing and answering. The portable memory media uses one of a wireless audio receiver/transmitter unit and an audio receiver/transmitter unit for peer-to-peer voice conversation to overcome the limitation of requiring the network communication software to be built-in the computer system.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of the computer system according to a preferred embodiment of the present invention.

FIG. 2 shows a block diagram according to a preferred embodiment of the present invention.

FIG. 3 shows a schematic diagram of the computer system according to another preferred embodiment of the present invention.

FIG. 4 shows a block diagram according to another preferred embodiment of the present invention.

FIG. 5 shows the flowchart for operating the portable Internet phone according to the present invention.

### DETAILED DESCRIPTION OF THE INVENTION

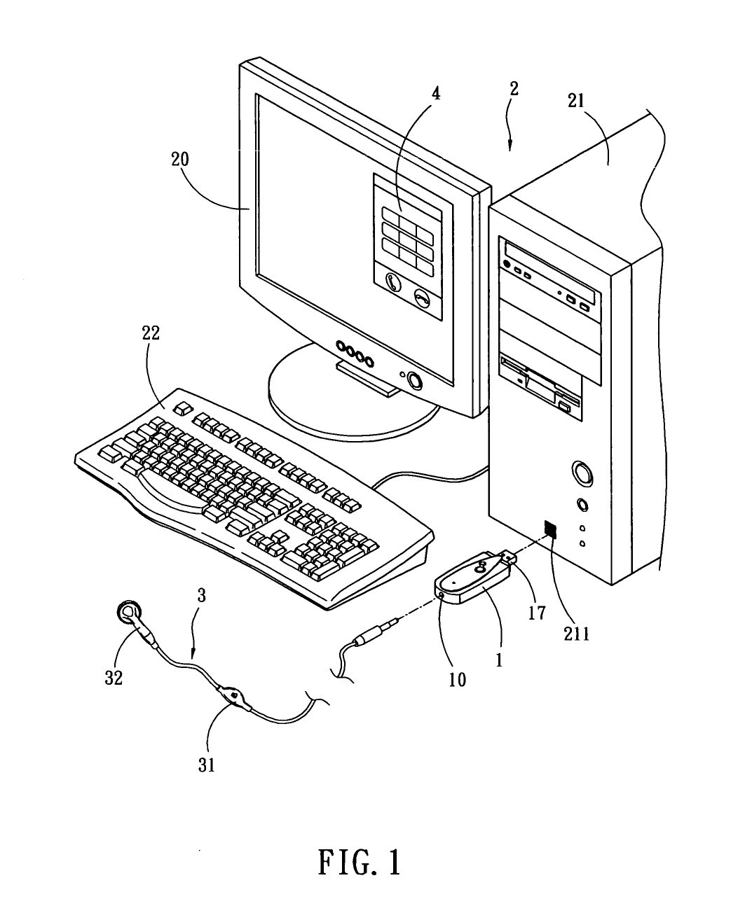

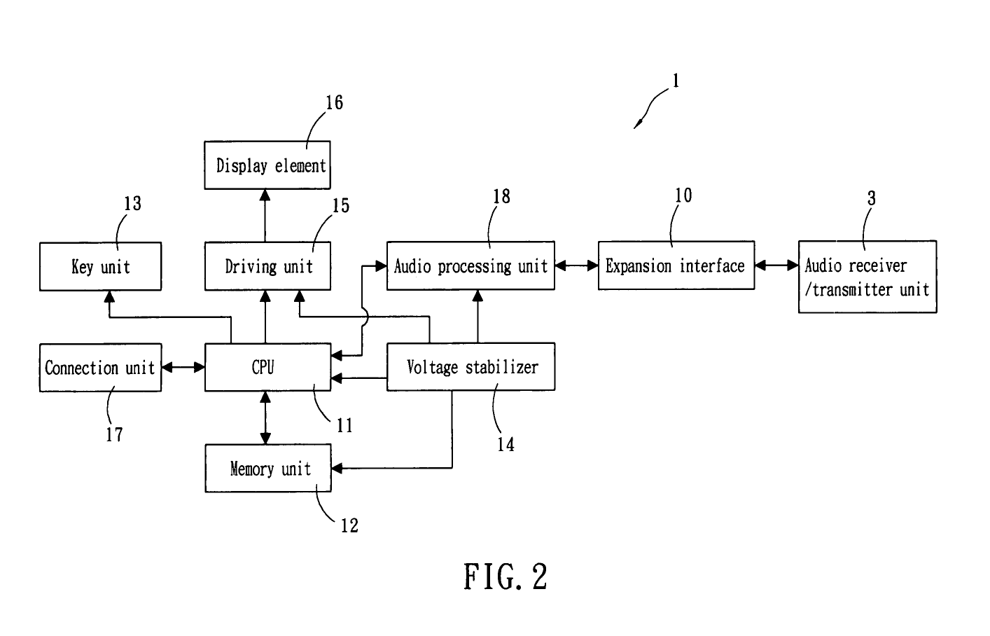

With reference to FIGS. 1 and 2, the portable Internet phone according to the present invention comprises a portable memory media 1 and a computer system 2 accessible to Internet. The computer system 2 comprises a connection port 211 for the connection of the portable memory media 1. Therefore, the portable memory media 1 can access a network server through the computer system 2 for real-time network dialing and conversation.

The computer system 2 comprises at least one display unit 20, a host 21 and an input unit 22 and the host 21 comprises the connection port 211 for the connection of the portable memory media 1.

The portable memory media 1, for example, is one of MP3 player, thumb drive, recording pen with storage memory. The portable memory media 1 comprises a processor 11 (CPU or DSP), a memory unit 12 connected with the processor 11 and used for memory storage, a key unit 13, a voltage stabilizer 14, a driving unit 15 and a display element 16 such as an LED and LCD display. The portable memory media 1 is electrically connected to the connection port 211 of the host 21 through an electrical connection unit 17 such as USB connector or a USB connection line. The portable memory media 1 further comprises an audio processing unit 18 to externally connect to at least one audio receiver/transmitter unit 3, such as a microphone 31 and an earphone 32, through an expansion interface 10 for audio signal reception and transmission.

The network communication software can be an Internet phone program for peer-to-peer voice transmission program, such as PEER-CALL WIN, or SIP phone, which are installed in the portable memory media 1. After the portable memory media 1 is electrically connected to the connection port 211 of the host 21, an installing program is executed automatically to link the network communication software and the host 21, and a network communication link is established between the host 21 and a network server. At the same time, the network communication software will display a dialing number keypad 4 or a phone address book on the display unit 20, whereby user can dial a phone number for the called party.

The network communication software can be normally installed on the portable memory media 1 and enables user to access the computer system 2 without built-in network communication software after the portable memory media 1 is connected with the computer system 2. The network communication software can then be linked to the computer system 2 and establishes a network connection by the network system and network server. The user can input the information of the called party or pick up phone call by using the dialing number keypad 4 or a phone address book on the display unit 20, or the input unit 22 of the computer system 2.

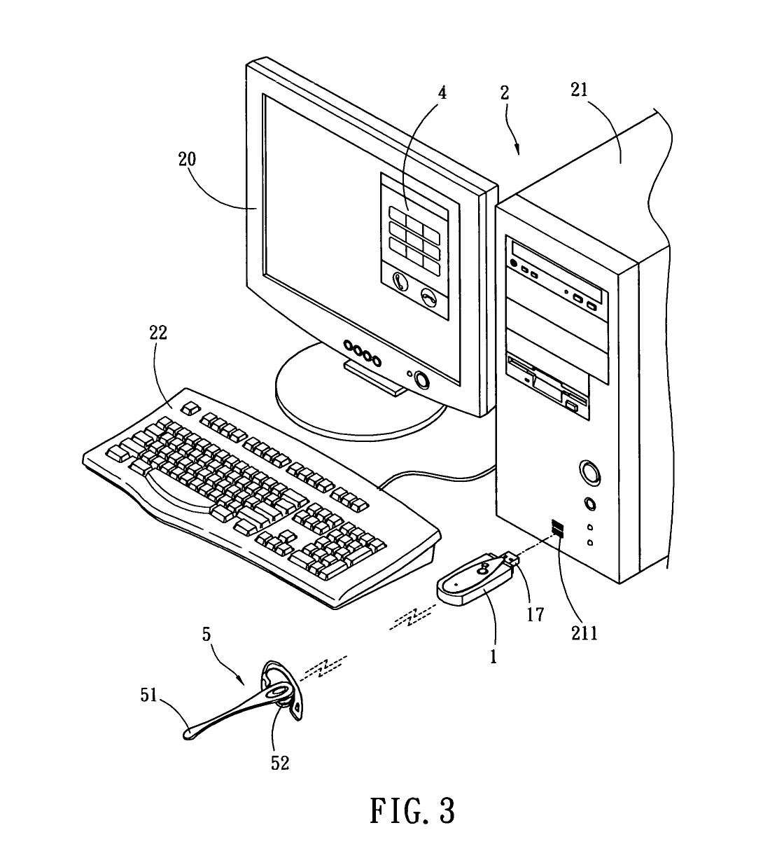

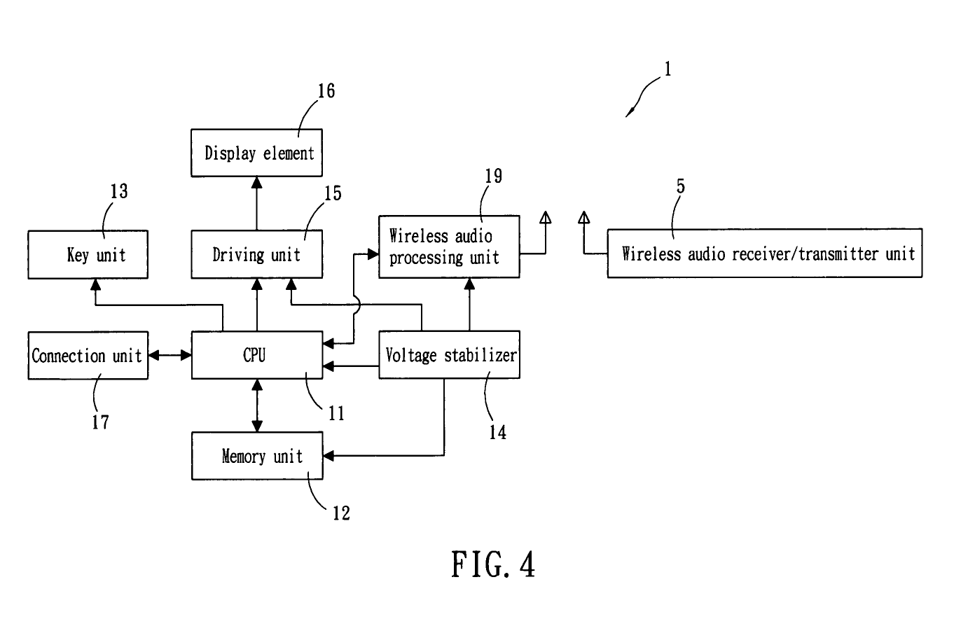

FIGS. 3 and 4 show another preferred embodiment of the present invention, which is similar to the preferred embodiment shown in FIGS. 1 and 2 except that the portable memory media 1 further comprises wireless signal reception/transmission function such as a wireless audio processor 19 with bluetooth, RF, or infrared transmission function, and at least one wireless audio reception/transmission unit 5 with wireless signal reception/transmission function such as microphone 51 or earphone 52 for voice input and output function.

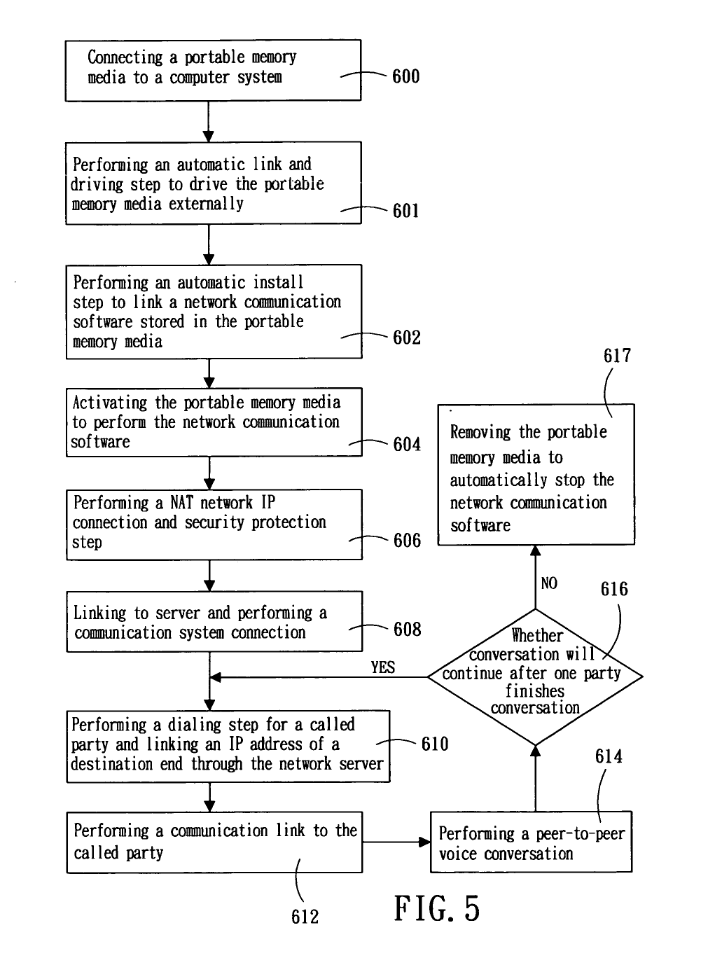

FIG. 5 shows the flowchart for operating the portable Internet phone according to the present invention, which is exemplified with Internet phone, PEER-CALL WIN PEER TO PEER phone or SIP phone.

At first, the portable memory media 1 is connected to the computer system 2 in step 600.

Au automatic link and driving step is executed to enable the portable memory media 1 stored with PEER-CALL WIN application or SIP phone to access the computer system 2 in step 601, as the portable memory media 1 is connected to the computer system 2 through an electrical connection unit 17

An installing step is executed by the portable memory media 1 such that the network communication software stored in the portable memory media 1 has a software link with the computer system 2 in step 602.

The portable memory media 1 is activated and performs the network communication software in step 604.

An NAT (Network Address Translation) network IP connection and security protection step is performed in step 606. The network communication software performs an NAT network IP connection step and activates an anti-virus software or firewall software in the computer system 2 through a network system connected to the computer system 2.

A connection to server and a communication system link is performed in step 608. The computer system 2 is connected to a network server and a peer-to-peer connection is established by a PEER-CALL WIN software or an SIP phone software.

A dialing up step for called party is executed in step 610, wherein the calling party dials the number of the called party by using the dialing number keypad 4 or the phone address book on the display unit 20, or the input unit 22 of the computer system 2. The calling party is connected to an IP address used for the destination end and designated by the network server.

A communication link to the called party is established in step 612, wherein the network connection to the called party is established through the network server. The called party helps to establish the network connection by answering the phone call in response to a dialing and connection request of the calling party.

A peer-to-peer voice conversation is executed in step 614, the network connection to the called party is established in step 612, and then one of the audio receiver/transmitter unit 3 and the wireless audio reception/transmission unit 5 in the portable memory media 1 can be used for the peer-to-peer voice conversation. After the conversation for one party is over, a step 616 is executed to judge whether there is still another conversation. If true, the step 610 is executed. If false, the portable memory media 1 is removed and the computer system will automatically remove the communication program in step 617.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A portable Internet phone connected to a computer system to access Internet and establish network communication, the portable Internet phone comprising a portable memory media and the portable memory media comprising:
a central processing unit (CPU);
a memory unit electrically connected to the CPU and used to store a network communication software; and
an audio processing unit electrically connected to the CPU and used to process audio signal.

2. The portable Internet phone as in claim 1, wherein the portable memory media is one of a MP3 player, a thumb drive, and a recording pen.

3. The portable Internet phone as in claim 1, wherein the CPU is electrically connected to an electrical connection unit, the electrical connection unit is one of USB connector and USB connection line for connecting to the computer system.

4. The portable Internet phone as in claim 1, wherein the CPU is electrically connected to a key unit.

5. The portable Internet phone as in claim 1, wherein the CPU is electrically connected to a driving unit to drive a display element.

6. The portable Internet phone as in claim 5, wherein the display element is one of LED and LCD.

7. The portable Internet phone as in claim 1, wherein the CPU, the memory unit, the audio processing unit and the driving unit are electrically connected to a voltage stabilizer.

8. The portable Internet phone as in claim 1, wherein the audio processing unit is electrically connected to an expansion interface.

9. The portable Internet phone as in claim 8, wherein the expansion interface is electrically connected to an audio receiver/transmitter unit.

10. The portable Internet phone as in claim 9, wherein the audio receiver/transmitter unit comprises a microphone and an earphone.

11. A portable Internet phone connected to a computer system to access Internet and establish network communication, the portable Internet phone comprising a portable memory media and the portable memory media comprising:
a central processing unit (CPU);
a memory unit electrically connected to the CPU and used to store a network communication software;
a wireless audio processing unit electrically connected to the CPU and used to process audio signal, and
a wireless audio receiver/transmitter unit wireless connected to the wireless audio processing unit.

12. The portable Internet phone as in claim 11, wherein the wireless audio receiver/transmitter unit comprises a microphone and an earphone with wireless transmission technology.

13. A method for operating a portable Internet phone, comprising the steps of:
a) performing an automatic link and driving step to connect a portable memory media to a computer system and drive the portable memory media externally;
b) performing an install step to link a network communication software stored in the portable memory media such that the portable memory media is activated and performs the network communication software;
c) performing a NAT (Network Address Translation) network IP connection and security protection step, performing a network IP connection through the computer system and activating security protection on computer system;
d) linking to server and performing a communication system connection, wherein the computer system is linked to a network server and a peer-to-peer connection is established for the network communication software;
e) performing a dialing step for a called party, wherein a dialed number is input through a dialing number keypad and an IP address of a destination end is linked through the network server;
f) performing a communication link to the called party and establishing a network communication connection to the called party through the network server, herein the called party answers a dialing and a communication request of a calling party to establish the network communication connection; and
g) performing a peer-to-peer voice conversation, wherein the peer-to-peer voice conversation is performed by one of a wireless audio receiver/transmitter unit and an audio receiver/transmitter unit of the portable memory media.

14. The method for operating a portable Internet phone as in claim 13, further comprising the steps of:
judging whether conversation will continue after one party finishes conversation;
performing a dialing step for a called party if the conversation will continue; and
removing the portable memory media to automatically stop the network communication software if the conversation will not continue.
